(19) United States
(12) Patent Application Publication
(10) Pub. No.: US 2002/0157731 A1
(43) Pub. Date: Oct. 31, 2002

(54) Portable mitre saw extension table

(76) Inventor: Donald A. Harper, Jonesboro, GA (US)

Correspondence Address: William B. Noll, 402 Anemone Street, Panama City Beach, FL, 32413, US

(21) Appl. No.: 09/844,418

(22) Filed: Apr. 30, 2001

(51) Int. Cl. B25H 1/00

(52) U.S. Cl. 144/287

(57) ABSTRACT

A portable, elongated miter saw table for on-site placement on a supporting surface, such as an open tail gate of a pick up truck, or a pair of saw horses. The table includes a pair of extension members having a central well therebetween for receiving a miter saw. Each extension member includes a slidably engaging, U-shaped extension that features a raised transverse member, whereby the transverse, along with the extension members, define a continuous planar support work surface.

### FIELD OF THE INVENTION

This invention is directed to the field of portable power tool supports, more particularly to a portable extension table for a miter saw that features a central well for receiving the miter saw.

### BACKGROUND OF THE INVENTION

The present invention relates to a portable miter saw extension table that has utility for on-site use, such as in conjunction with the flat bed of a pick up truck, or with the use of conventional saw horses in one's basement work shop.

Saw horses, as known in the art, comprise a pair of legs hinged at the support end for receiving a table top or plural 2×4's to form a table for seating the miter saw or other power tool. Saw horses remain today as a convenient means to allow on-site use of power tools. More recent innovations have been developed to enhance the use of power tools at locations from one's workshop. Several of such innovations are reflected in the following U.S. patents:

a.) U.S. Pat. No. 5,863,052, to Roman, relates to a portable collapsible work station for quick set up and storage. The work station comprises an elongated frame structure including a pair of side frames. A collapsible wheel carrying frame is pivotally mounted at a first intermediate position of the elongated frame structure. The collapsible wheel carrying frame being pivoted on the elongated frame structure from a storage position lying within a horizontal plane through the elongated frame structure to an extended operating position for supporting the elongated frame structure. A support leg structure is pivotally mounted at a second intermediate position of elongated frame structure enabling the support leg structure to be moved from a storage position coplanar with the collapsible wheel carrying frame to the extended operating position for supporting the elongated frame structure. A power tool is rotatably secured to the elongated frame structure for rotation from a tool storage position located internally of the elongated frame structure to a tool operating position on top of the elongated frame structure.

b.) U.S. Pat. No. 5,518,053, to Robison, teaches a work support composed of a work surface mounted on a frame adapted to support a piece of work; and at least one laterally adjustable support cooperatively associated with the work surface. The adjustable support includes a support surface, at least one telescoping structure having a plurality of telescoping sections, wherein one of the telescoping sections has an end attached to the frame and another of the telescoping sections has an end in communication with the support surface.

c.) U.S. Pat. No. 5,329,979, to Miller et al., is directed to a portable work table adapted for being removably positioned within a storage compartment of a vehicle. The table includes a frame having an upper wall with a generally planar top surface, side walls extending from the upper wall and a bottom wall extending between the side walls. A plurality of legs are movably mounted on the frame and are movable between a first position such that the legs extend from the bottom surface for being engaged with a support surface such that the frame is positioned above the support surface to permit work to be readily carried out on the top surface and a second position such that the legs are retracted from the first position towards the bottom surface such that the frame is positionable within the storage compartment of the vehicle. A plurality of objects are movably mounted on the frame. A storage device is interconnected between the frame and each of the objects for allowing each object to move with respect to the top surface of the frame between a first position such that the object is positioned within the interior of the frame below the top surface and a second position such that the object is positioned at least partially above the top surface of the frame.

d.) U.S. Pat. No. 4,798,113, to Viazanko, relates to a table for a miter saw having an extension table detachably attached thereto at each end. The extension table carries a fence in alignment with the miter table fence, and the fence carries a movable stop and index scale. The stop can be fit on either the left or right extension table fence. The miter saw is preferably mounted on its own base, with the base being provided with wheels for easy transport and removable legs for support. The left and right extension tables each have pivotable support legs and, when detached, the extension tables are carried and protected in a carrying

Only the patent from the above selection dealing exclusively with miter saws, and the problems associated therewith, is the patent to Viazanko. As is known in the woodworking trades, miter saws are extensively used in finish carpentry. When finish coping, baseboard and other trim strips are applied, they must be accurately cut to length and accurately cut to the proper angle, such as 45°, for joining the adjacent trim. A miter saw has a table which carries a fence, a base having a table surface, and a rotary saw blade that is pivoted about a swing axis, and the blade can be swung down at least partially into a slot in the table surface. Additionally, the saw is mounted to rotate about an upright axis so that the angle of the blade, with respect to the fence, can be adjusted.

A short coming of miter saws is that often the trim or other item to be cut is quite long compared to the table surface. As a consequence, there may be considerable overhang which can be difficult to control to make the desired precise cut. Extension tables, such as taught in Viazanko, have thus been proposed to alleviate some of the concerns with cutting long pieces of trim. Unfortunately, using such extension tables can be difficult to transport to on-site locations where the miter saw may required. Ease of transportability and set up are critical to an effective use of a miter saw away from the convenience of a workshop.

The present invention represents an effective means to mount a miter saw for on-site use, where extension members are provided that are flush with the table surface of the miter saw, thus ensuring an extensive planar surface to support a long piece, such as wood trim, for cutting. The manner by which this invention achieves the goals hereof will become more apparent in the description which follows, particularly when read in conjunction with the accompanying drawings.

### SUMMARY OF THE INVENTION

This invention relates to a readily transportable, easy to set up miter saw support for use at job site locations. The miter saw support comprises an elongated table having a central well for receiving the miter saw and a pair of aligned table extensions, where the supporting surfaces of the respective extensions are planarly aligned with the table surface of the miter saw. Each extension includes a pair of side members having plural lateral members to define the supporting surface thereof. Additionally, a telescopic member, slidably received within the respective side members, is provided, where the telescopic member includes a cross member having a raised surface that is flush with the supporting surface of the side members and corresponding plural lateral members. By this arrangement, a long planar support is achieved for precise cutting of extended wood pieces, such as trim, etc. For ease of transportability, the under surface of one extension may be provided with a pair of wheels to allow movement and placement of the miter saw support.

Accordingly, an object of this invention is to provide a portable miter saw table, for job site use, that, by the use of extensions, ensures easy control in the precise cutting of long, often difficult to handle wood strips.

Another object hereof is the provision of a pair of sliding extensions that ensures an extended planar support surface for elongated pieces of wood strips, such as trim.

Still another object of the invention is the provision of a central well in the miter saw table for recessing the miter saw to provide a planar support surface in cooperation with the table surface of the miter saw.

These and other objects of the invention will become apparent from the further description which follows.

### BRIEF DESCRIPTION OF DRAWINGS

FIG. 1 is a perspective view of the portable miter saw extension table according to the present invention.

FIG. 2 is a partial side view illustrating the sliding extension for the portable miter saw table of this invention, showing in particular the raised surface portion to provide a planar surface with the table.

### DETAILED DESCRIPTION OF PREFERRED EMBODIMENT

The present invention is directed to a portable miter saw extension table that has particular utility for transporting and set up at job site locations. The miter saw extension table hereof will now be described with regard to the two Figures, where like reference numerals represent like components or features in the respective Figures.

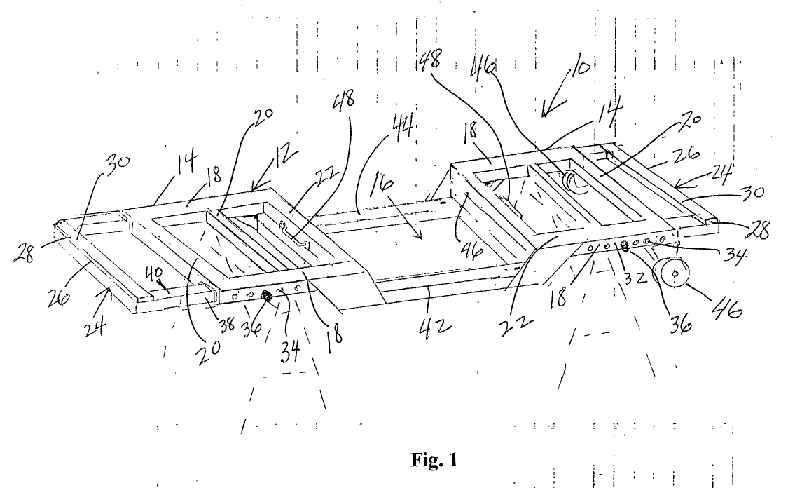

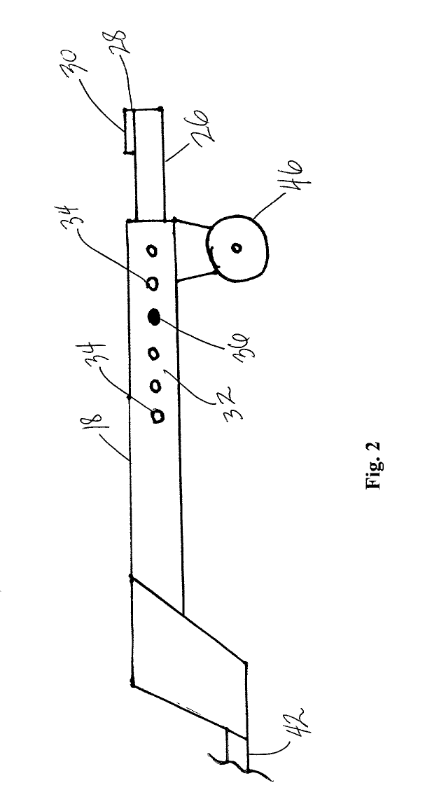

Turning now to FIGS. 1 and 2, illustrating the structural details of the miter saw extension table 10 of this invention, the miter saw extension table 10 comprises an elongated frame member 12 having a pair of table extensions 14, with a central well 16 for receiving the miter saw (not shown), as known in the art, therebetween. The table extensions 14 each consist of a pair of parallel side members 18, preferably formed of tubular, rectangularly configured aluminum, with plural transverse members 20, where the respective upper surfaces 22 define a planar work piece supporting surface. Additionally, the respective side members 18 receive slidable, U-shaped extensions 24, where the closed end 26 includes a raised surface 28 such that the upper surface 30 is coextensive to the upper surfaces 22 of the table extensions, note in particular FIG. 2. By this arrangement, a flush supporting surface of extended length is provided to ensure support for a wood piece placed thereon. Finally, to temporarily fix the relationship between the extension 14 and its sliding U-shaped extension 24, the vertical wall 32 may include a series of openings 34 for temporarily engaging a spring biased button 36 along the vertical wall 38 of the legs 40 of the U-shaped extension, a known latching mechanism for telescopically engaging members.

Between the respective table extensions 14 is a central well 16, defined by front and rear supports 42, 44, respectively, and side walls 46, where such side walls form part of the adjacent table extension 14. Most currently available miter saws include a housing featuring an upper support surface, where the depth of the housing is of one or two dimensions, and the difference therebetween is about 1″. Thus, the depth of the central well is of a dimension to receive the thicker housing, whereby the upper support surface is coextensive with the upper surfaces 22. Accordingly, a continuous support surface for the wood product is provided, whereby to facilitate user control of such wood product. In the event the smaller miter saw is used, a simple rectangular insert (not shown) may be placed on the supports 42, 44 in the well 16 to raise the smaller miter saw to a proper height to ensure the continuous support surface for the wood product being cut.

To facilitate transporting of the elongated frame member 12, a pair of rollers 46, positioned on the underside of one table extension 14, may be provided. That is, the frame member 12, held at the opposite end by hand gripping the second table extension, may be wheeled to and positioned at the desired location. Additionally, a further pair of handles 48 may be included to lift the frame member 12 into position. A preferred placement for the portable miter saw table may be on the rotated or extended tail gate of a pick up truck, or on a pair of conventional saw horses (shown in phantom in FIG. 1).

It is recognized that changes, variations and modifications may be made to the portable miter saw table of this invention, especially by those skilled in the art, without departing from the spirit and scope thereof. Accordingly, no limitation is intended to be imposed on the invention except as set forth in the accompanying claims.

1. A portable, elongated miter saw table comprising an elongated metal frame formed by a pair of extension members separated by a central well for receiving a miter saw, where said miter saw includes a work support surface, each said extension comprising a pair of side members and plural transverse members having upper surfaces planarly arranged with the complementary upper surfaces of said other extension member, said side members further receiving in sliding engagement a U-shaped extension, where the U-shaped extension features a transverse member having an upper surface coextensive with the upper surfaces of said side and plural transverse members, whereby to define a continuous support surface in cooperation with said work support surface of said miter saw.

2. The portable, elongated miter saw table according to claim 1, wherein said elongated metal frame includes a lower surface for said extension members, and one said lower surface mounts a pair of rollers for the easy, manual movement of said miter saw table.

3. The portable, elongated miter saw table according to claim 1, wherein said U-shaped extensions include a pair of free legs for telescopically engaging said side members, and means are provided for selectively fixing the relationship of said U-shaped member to its respective extension member.

4. The portable, elongated miter saw table according to claim 3, wherein said means includes a series of openings along said side members, and said free legs include a spring biased button for engaging a selective said opening.

5. The portable, elongated miter saw table according to claim 1, including a pair of opposing handles to facilitate lifting and placement of said table on a supporting surface.
